(19) United States
(12) Patent Application Publication
(10) Pub. No.: US 2013/0275506 A1
(43) Pub. Date: Oct. 17, 2013

(54) LYRIC POSTING, LIVE TRACK SHARING, AND ZIP CODE NOTIFICATION OF MUSIC EVENTS

(71) Applicant: J. Scott Warner, Orem, UT (US)

(72) Inventor: J. Scott Warner, Orem, UT (US)

(21) Appl. No.: 13/838,975

(22) Filed: Mar. 15, 2013

Related U.S. Application Data
(60) Provisional application No. 61/623,181, filed on Apr. 12, 2012.
(60) Provisional application No. 61/640,820, filed on May 1, 2012.
(60) Provisional application No. 61/748,525, filed on Jan. 3, 2013.

(51) Int. Cl. H04L 29/08

(52) U.S. Cl. CPC H04L 67/22
USPC 709/204

(57) ABSTRACT

Providing a user status, the user status comprising a portion of a published work. A method includes receiving user input; determining a relationship of the user input to one or more published works; displaying to the user different portions of the one or more published works; receiving user input selecting at least one of the different portions of the one or more published works; and posting the selected portions to a user's status accessible to one or more other users.

### CROSS-REFERENCE TO RELATED APPLICATIONS

This application claims the benefit of U.S. Provisional application 61/623,181 filed Apr. 12, 2012, titled “LYRIC POSTING, LIVE TRACK SHARING, AND ZIP CODE NOTIFICATION OF MUSIC EVENTS”, U.S. Provisional application 61/640,820 filed May 1, 2012, titled “LYRIC POSTING, LIVE TRACK SHARING, AND ZIP CODE NOTIFICATION OF MUSIC EVENTS”, and U.S. Provisional application 61/748,525 filed Jan. 3, 2013, titled “LYRIC POSTING, LIVE TRACK SHARING, AND ZIP CODE NOTIFICATION OF MUSIC EVENTS”, which are incorporated herein by reference in their entireties.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Many computers are intended to be used by direct user interaction with the computer. As such, computers have input hardware and software user interfaces to facilitate user interaction. For example, a modem general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Interconnected computing devices with rich interfaces have allowed users to share information with each other. Recently, many “social media” type websites and device “apps” have been developed to allow users to quickly and efficiently share information. While it is often simple for a user to share their own thoughts, feelings, or actions that they are able to manually enter into a status, it is more difficult to find the works of the others that may be used to more eloquently or meaningfully express a thought, emotion, or action.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method that may be practiced in a social networking computing environment. The method includes acts for providing a user status, the user status comprising a portion of a published work. The method includes receiving user input; determining a relationship of the user input to one or more published works; displaying to the user different portions of the one or more published works; receiving user input selecting at least one of the different portions of the one or more published works; and posting the selected portions to a user's status accessible to one or more other users.

Another embodiment illustrated herein is directed to a method that may be practiced in a social networking computing environment. The method includes acts for providing real time indication of a song that a user is listening to. The method includes determining a song that a first user is listening to; determining a tracker location of the song that the user is listening to; publishing the song that the user is listening and the tracker location to a social networking site or application; providing a user interface that allows a user of the social network site or application to listen to the song at the same tracker location if the user has the song in their music collection and to download the song if the user does not have the song in their music collection allowing the second user to substantially simultaneously listen to the song with the first user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a login interface for a lyric sharing application;

FIG. 1B illustrates a search page for a lyric sharing application;

FIG. 1C illustrates a search results page for a lyric sharing application;

FIG. 1D illustrates a lyric selection page for a lyric sharing application;

FIG. 1E illustrates a lyric selection page with lyrics selected for a lyric sharing application;

FIG. 1F illustrates additional portions of a lyric selection page for a lyric sharing application;

FIG. 1G illustrates a feed page for a lyric sharing application;

FIG. 2 illustrates a user interface for live listening sharing;

FIG. 3A illustrates a feed page for a lyric sharing application;

FIG. 3B illustrates a feed page showing images for a lyric sharing application;

FIG. 3C shows a lyric search page for a lyric sharing application;

FIG. 3D illustrates a song selection page for a lyric sharing application;

FIG. 3E illustrates a lyric selection page for a lyric sharing application;

FIG. 3F illustrates a tag selection results page and a photo button for a lyric sharing application;

FIG. 3G illustrates camera view page for a lyric sharing application;

FIG. 3H illustrates an activated word display for a lyric sharing application;

FIG. 4 illustrates a photograph with text overlaid;

FIG. 5 illustrates a method of providing a user status based on a public work; and

FIG. 6 illustrates a method of providing a real time indication of a song to which a user is listening.

### DETAILED DESCRIPTION

One embodiment illustrated herein implements lyric posting. Lyric posting is based on people being able to express themselves through social media with lyrics found in songs. The lyrics are found through a lyric company's database based on user input into a user interface. Lyric companies' databases may have millions of songs to choose from. Various commercial lyric companies exist and could be used interchangeably for this service. A user will be able to type in what they are feeling and wanting to express to their followers into a user interface of a website or app such as that illustrated in the attached Figures. A server will then search the lyric company's database for the songs containing the lyrics searched for by the user.

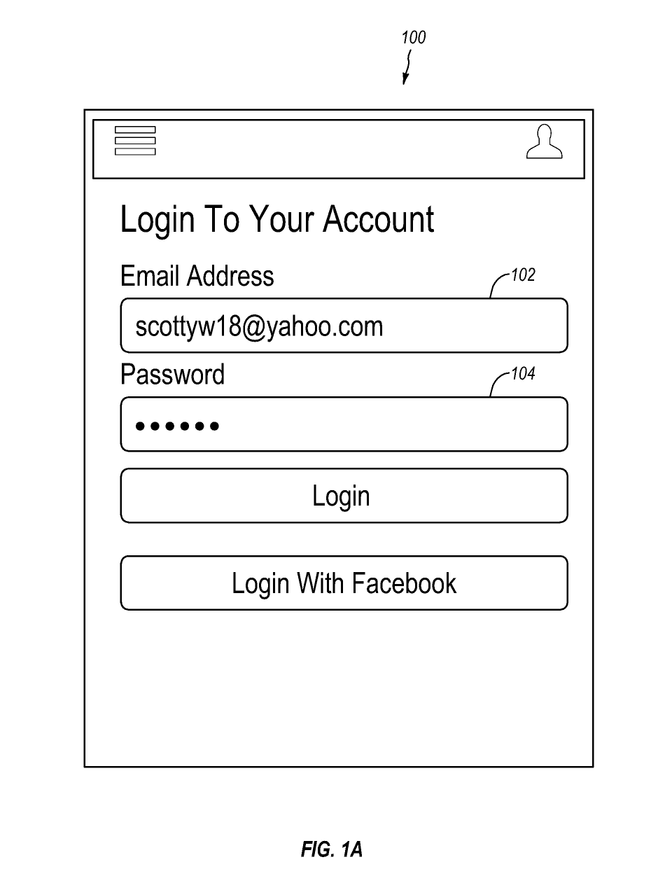

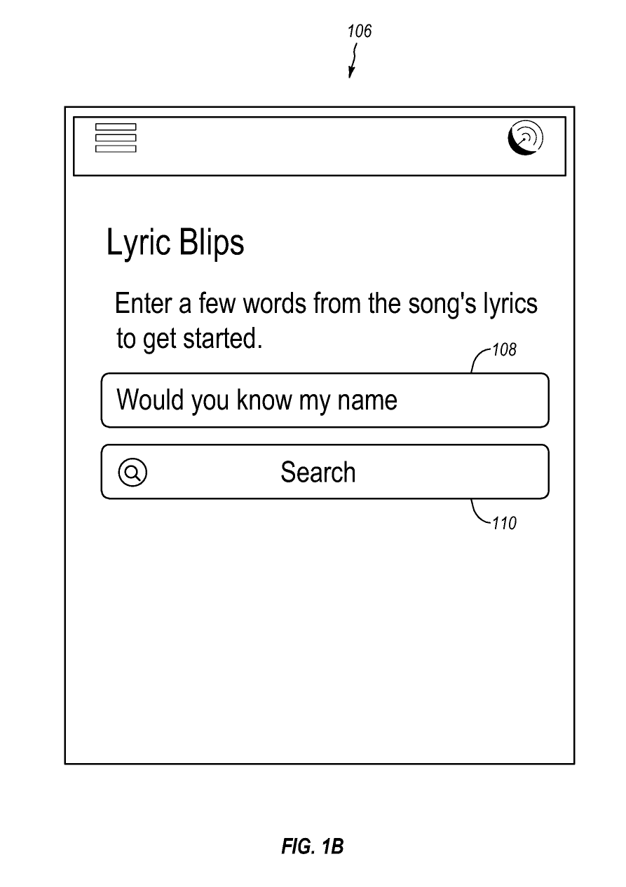

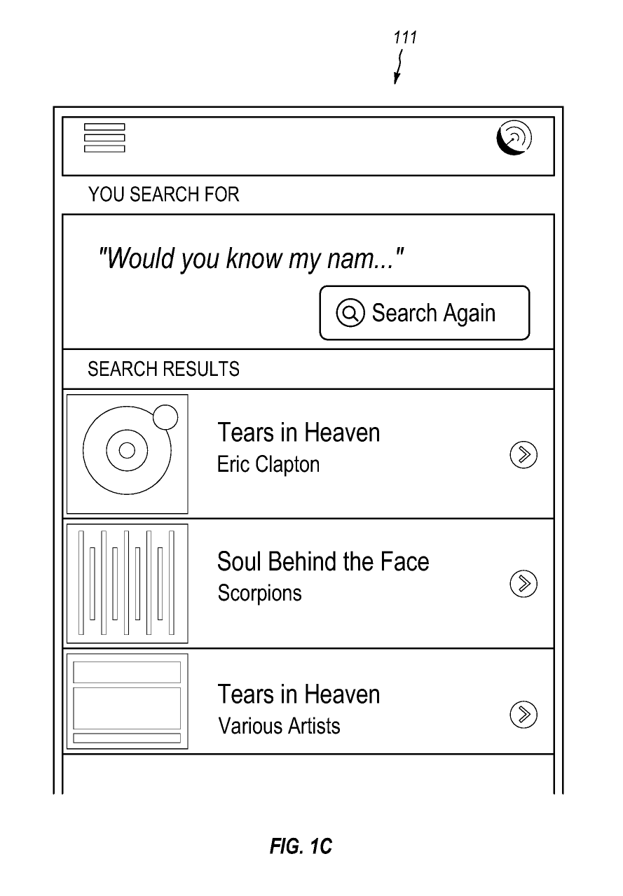

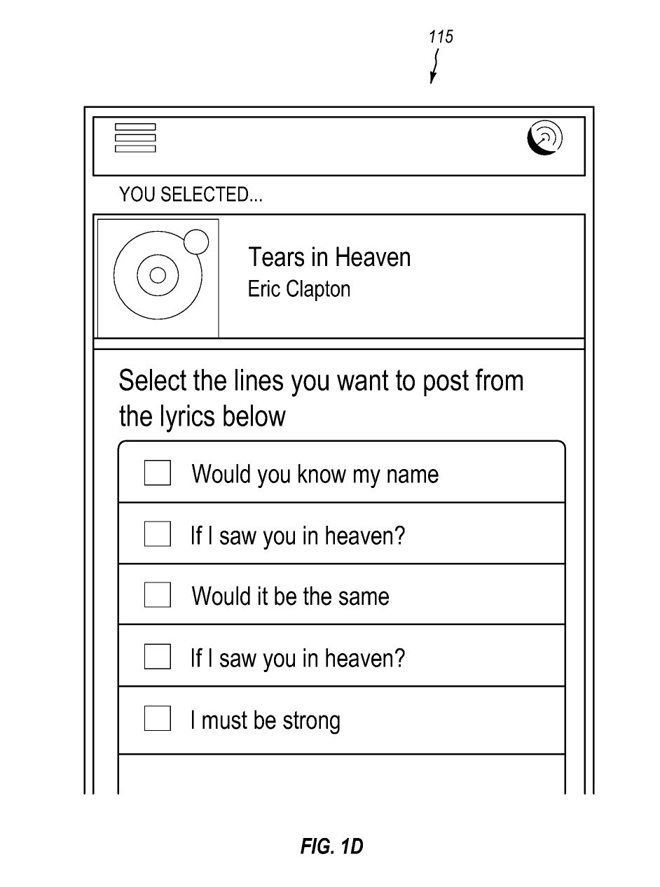

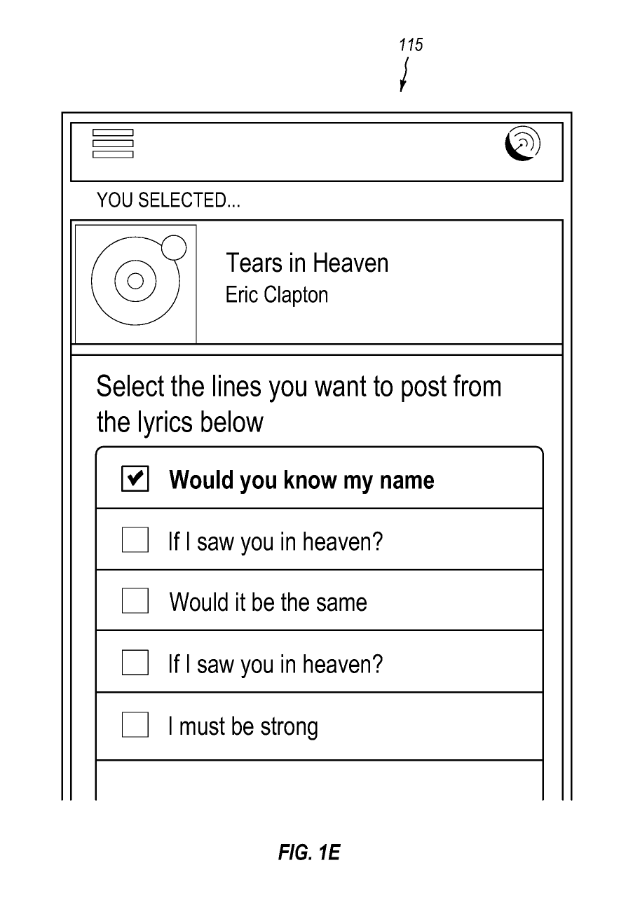

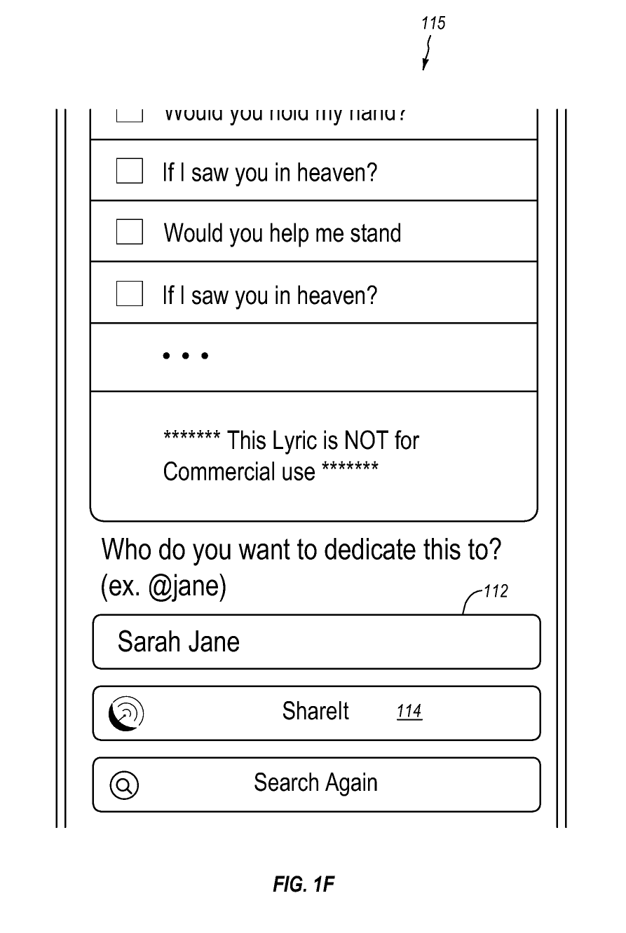

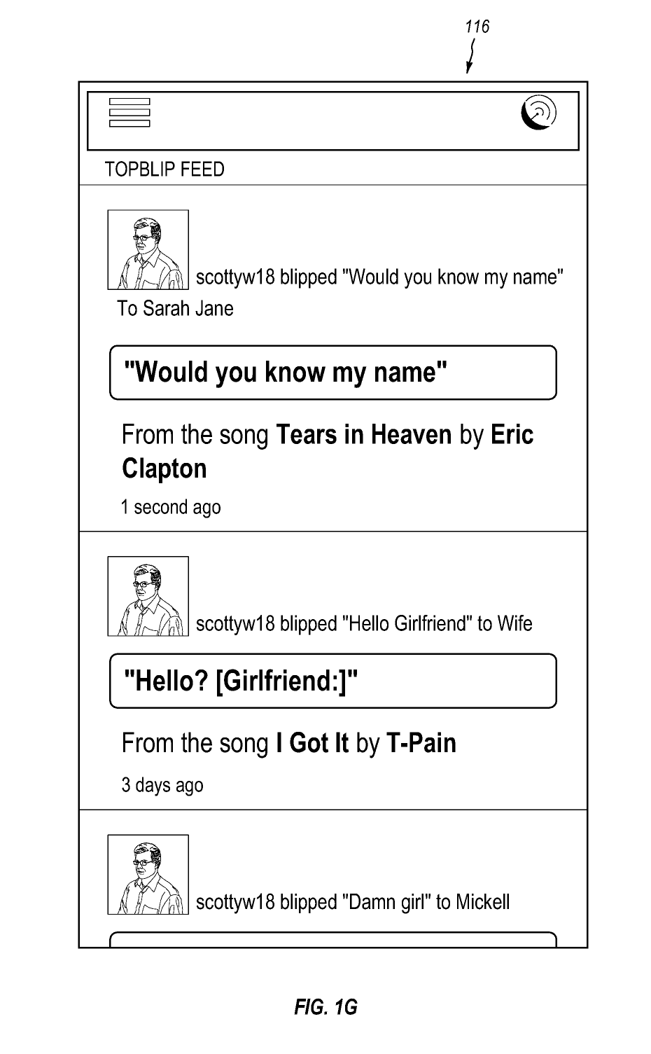

Reference is now made to FIG. 1A-1G to illustrate a specific example. FIG. 1 illustrates that a user is able to log into their lyric posting account. In particular, a user can enter an email address (or other username token) as illustrated at 102 and a password as illustrated at 104 into a log-in page 100. Alternatively, a user may log in using a single sign in account. For example, several different accounts may be connected allowing a user to use a single sign in for all of the different accounts.

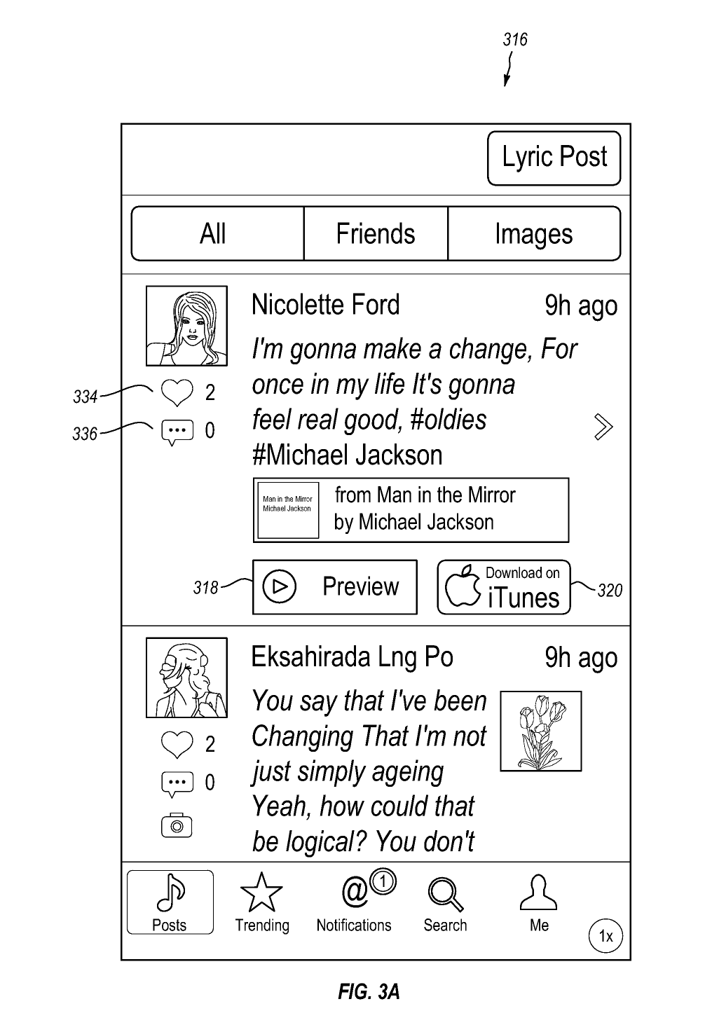

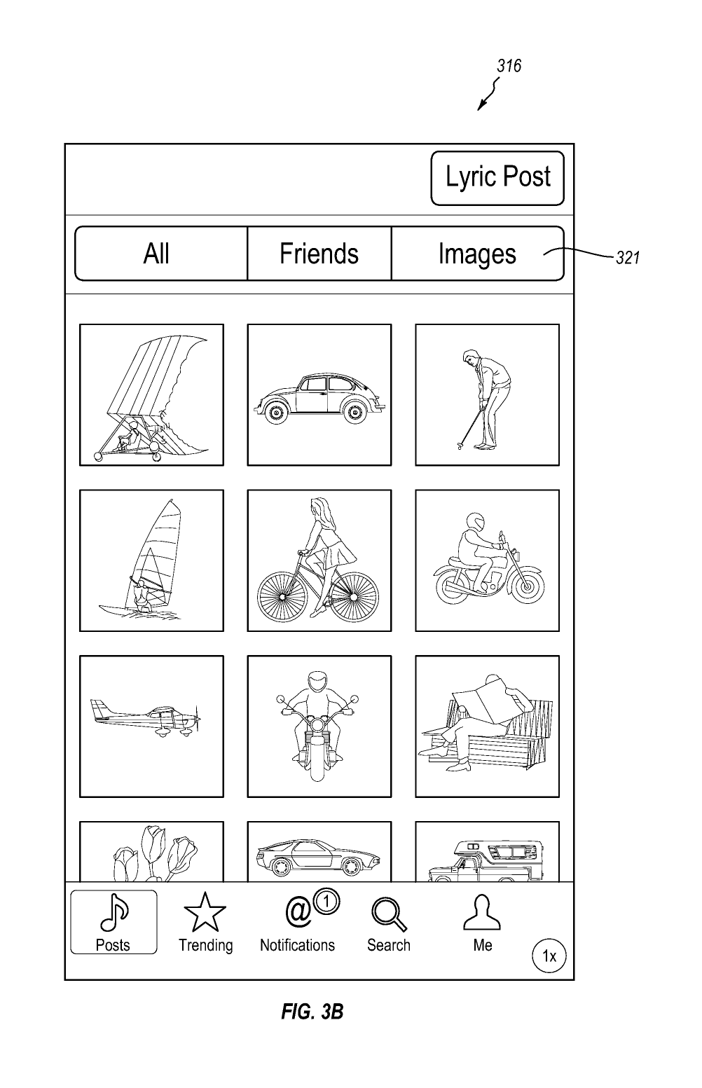

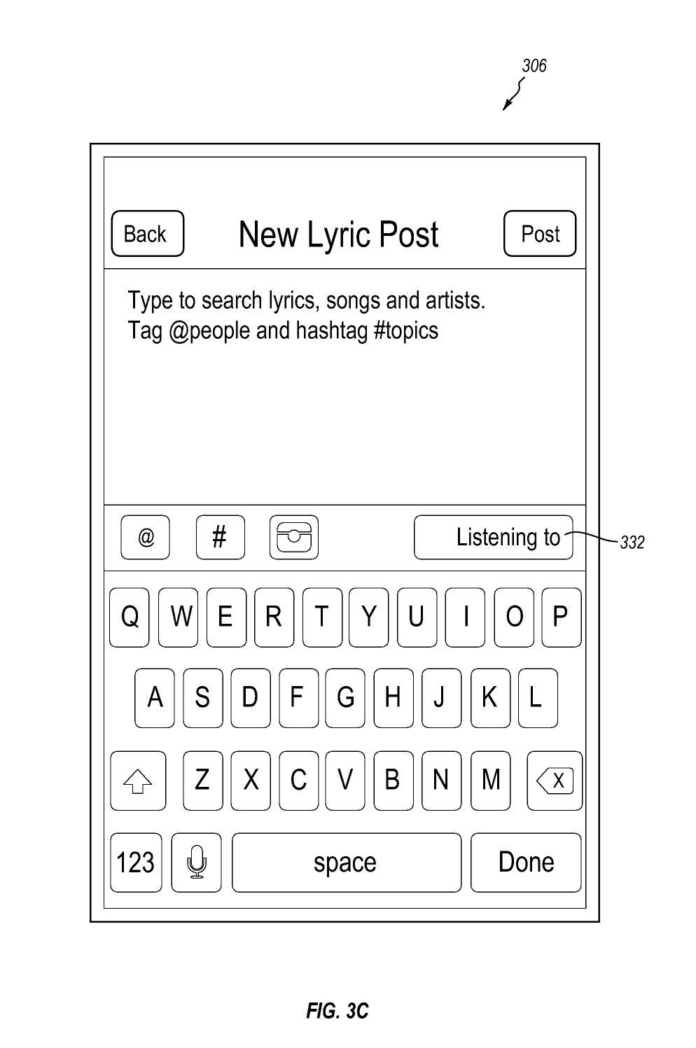

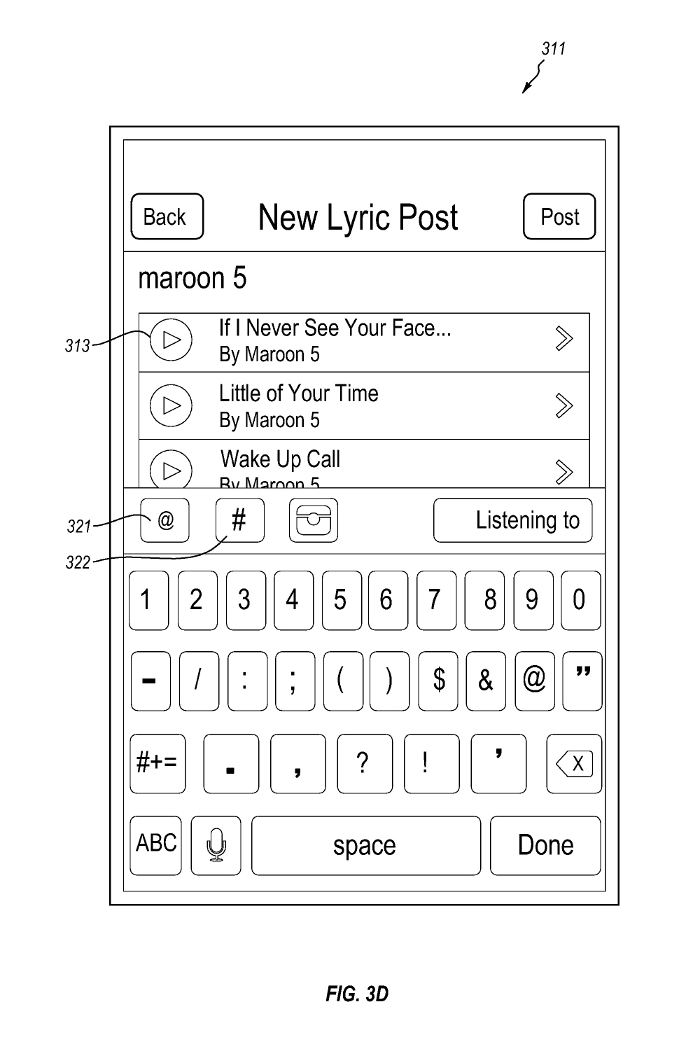

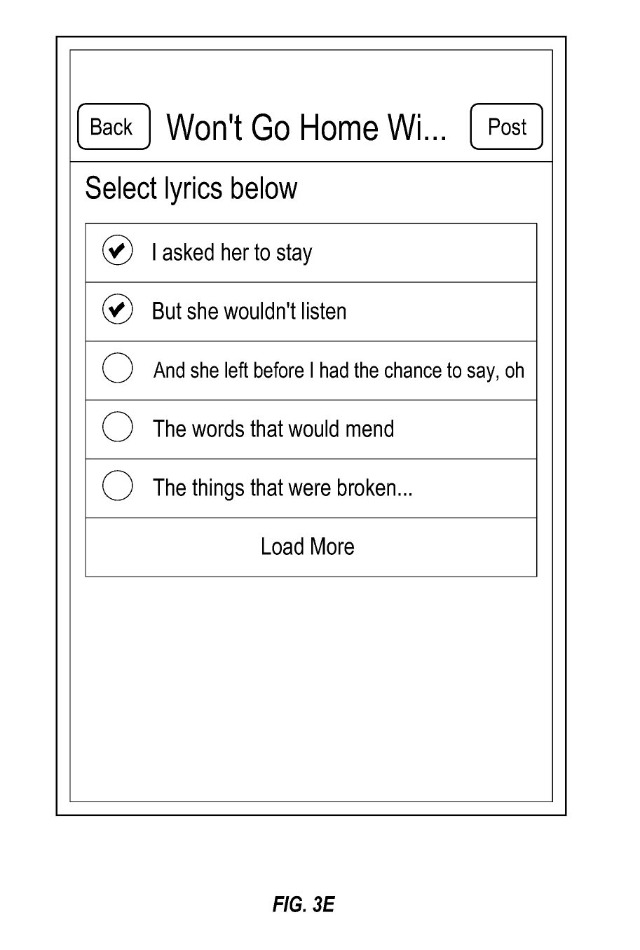

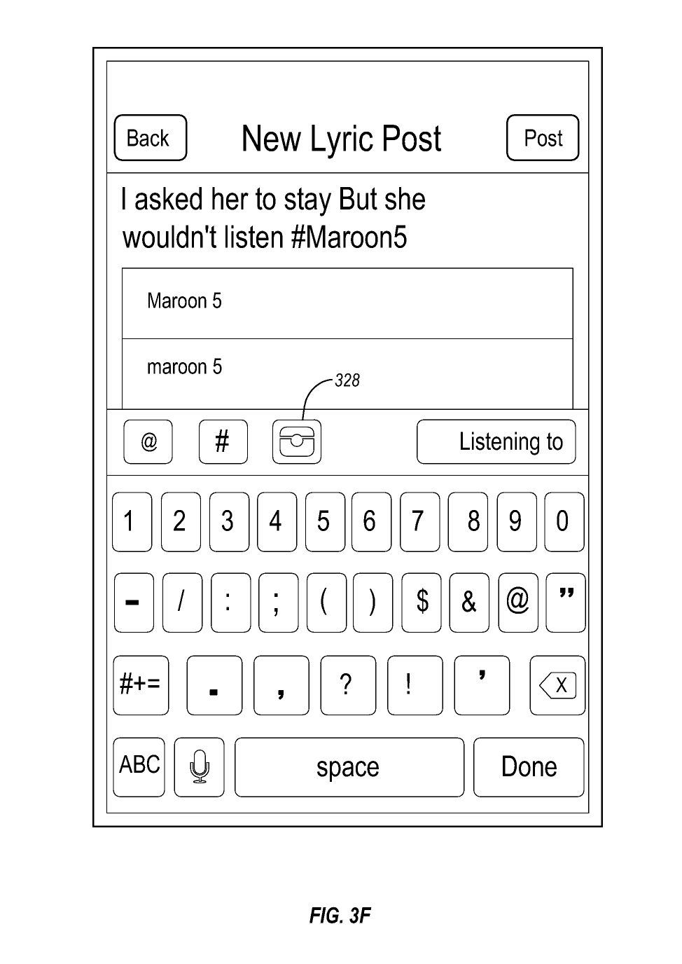

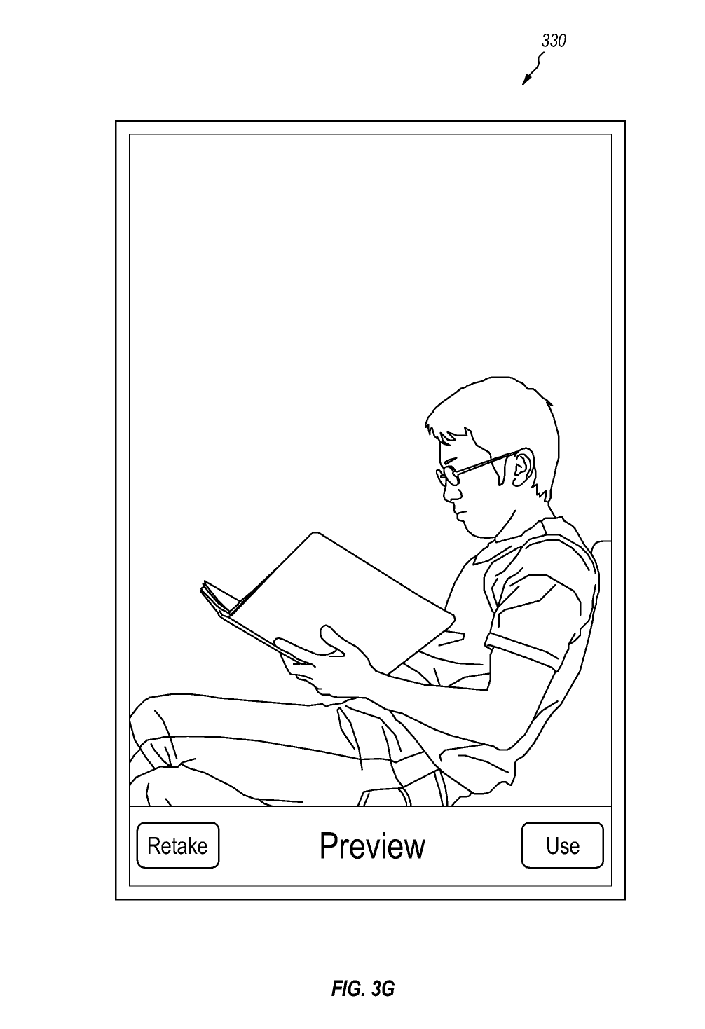

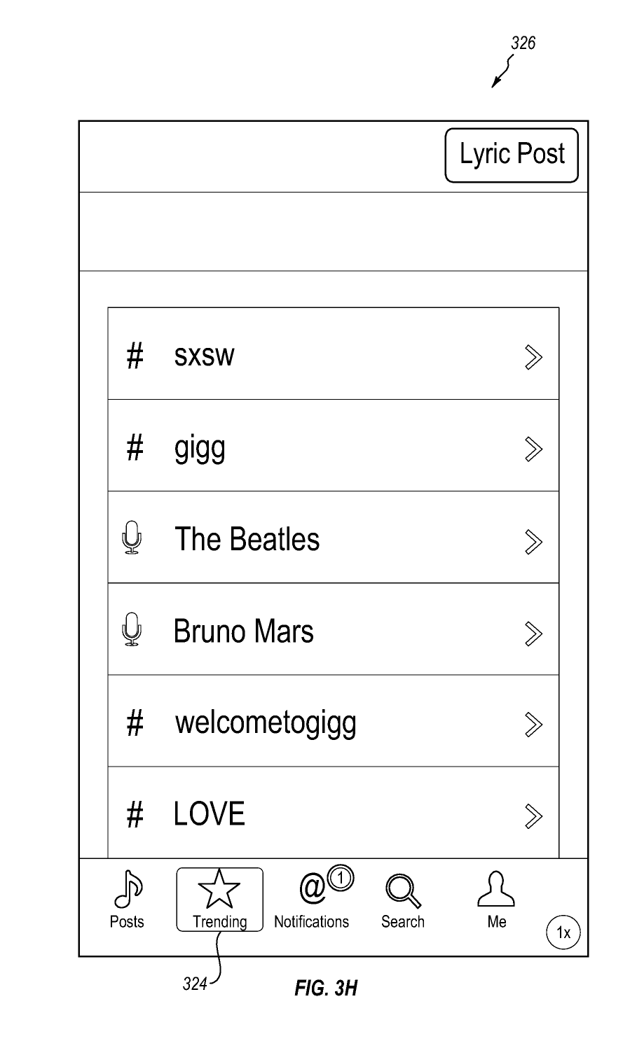

As illustrated in FIG. 1B, the user is then presented with an input page 106. In the illustrated example, a boy wishes to reach out to a girl and types “Would you know my name” in the search space 108. He pushes the search button 110 and a list of songs by different artists and/or in different albums with the sentence “Would you know my name” (or similarly worded phrases) show up as illustrated in FIG. 1C. Notably, embodiments may include functionality for “similar” searching. For example, searches for “will you know my name” or “would you know my identification” might return the same list of songs based on similarity of words or phrases to words or phrases in song lyrics. In some embodiments, the search can be submitted to a lyric provider website or other search provider and the results from that lyric provider website can be used to formulate results for a user. FIG. 3 C illustrates an alternate interface that may be used to search for songs and/or lyrics.

In the illustrated example, the list of songs is also illustrated in a results page 111 with album cover artwork for each song, and a user interface element allowing a user to play a preview of each song for which a preview exists. This is illustrated in FIG. 3D, which shows a results page 311 and a preview interface element 313. In some embodiments, this may be done by displaying an iTunes (available from Apple Inc. of Cupertino, Calif.) preview of the song. The user sees the top song with those lyrics is “Would You Know My Name” by Eric Clapton. He clicks on the song.

This causes the user interface to display the song in a lyrics page 115, including displaying every lyric within the track. In this example, the lyrics are grouped and displayed by phrases. The user selects the line (as illustrated in FIG. 1E) he had searched for “i.e. “Would you know my name”, which may be highlighted in green or in bold letters or otherwise distinguished. He can also click on other lyrics within the song that he feels go along with what he is trying to express to the girl. He can use numerous lyrics from the song. FIG. 3E shows an example where multiple phrases of lyrics are selected. While in the illustrated example, the lyrics are divided up by phrase with a check box next to each phrase, other embodiments may be implemented. For example, in some embodiments, the interface may display the entire set of lyrics for a song and a user highlights which lyrics they want to post.

He then scrolls to the bottom of the page (as illustrated in FIG. 1F) where he finds an interface 112 where he can enter a user with whom he wishes to share the lyric. Here, he can enter the name of the girl (i.e. Sarah Jane). This is an option to tag someone—not a requirement to post. Alternatively, as illustrated in FIG. 3D, a user can select an @ user interface element 321 which will provide the user with an interface to enter one or more users to which the user wishes to share the lyrics with. He will then be asked or prompted to sync his lyric post to a social media site, such as Twitter, a social media site available from Twitter, a private company of San Francisco, Calif. & Facebook, a social media site available from Facebook Inc. of Menlo Park, Calif. When he pushes a send button 114, the selected lyrics it will show up in a service site for the lyric sharing service (as illustrated in the feed page 116 illustrated in FIG. 1G), and/or any site he chose to sync his post to (e.g. Facebook, twitter, etc.), and on the page of his girlfriend (e.g. her Facebook, twitter, personal web page, lyric sharing service account page, etc.).

In some embodiments, when the songs searched for with the lyric show up within an application, Facebook, Twitter, the lyric sharing service, or other social media tool, there may be an option to purchase the song through an affiliate such as iTunes, and/or other music source. Embodiments may include functionality for users interested in the lyric post song to “preview” the song before purchasing. For example, FIG. 3A illustrates an alternate version of a feed page 316 which includes a preview button 318 and a purchase button 320 to preview and purchase a song respectively.

Once the song/lyric is posted to a site, such as a social media site like Facebook it may be able to be played through on-line streaming services, such as those provided by Spotify, a private company of London, England.

Embodiments may include “active” words available to post in the lyric post search bar (example: “You never loved me . . . ” is the lyric post. The word “loved” would be considered “active”.) To make a word “active” a user may place a hash tag in front of the word while typing in the lyrics they are currently searching for (example: “You never #loved me . . . ”). It would then open a list of the most popular songs with the lyrics “loved” or “love” searched for and “activated” by other users. Alternatively, some embodiments may include a hashtag user interface element 322 that the user can select for adding active words.

The lyrics being hash tagged or “activated” will become trending posts depending on how many users are “activating” them. For example, as illustrated in 3H, a user can select a trending tab 324 which will display popular activated words in an activated word display 326. This will encourage another push in social networking. It will help promote users connecting with other users in a system database on certain lyric topics and discussions. If a user is not able to think of particular lyrics in a song to express themselves then embodiments may provide a way for them to search “active” words like #happy, #sad, #breakup, #boyfriend, #girlfriend, #broken, #love, etc. This will help them easily find what they are looking for. They of course will still be able to just type in what they are feeling and wanting to express, and likely find those lyrics in a random song, but this will make things even easier for users.

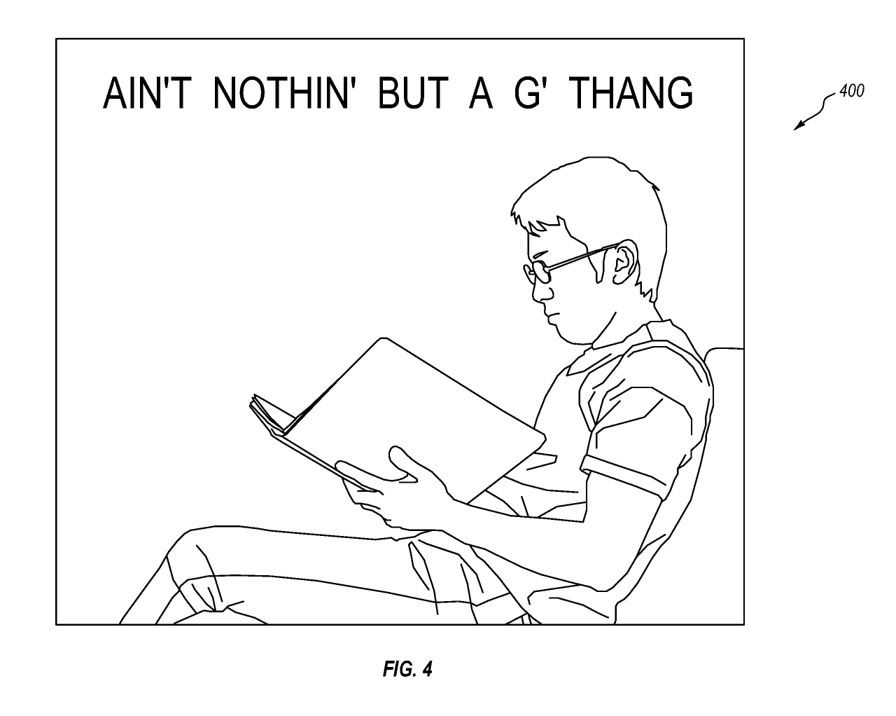

In some embodiments, a user may be able to select a photo or other image that can be posted with the lyrics. For example, a user may be able to take a picture, or select a picture from their phone or other device. The picture can then be posted with the lyrics or other published work. For example, FIG. 3F illustrates that a user can select a photo button 328. This causes a user to be presented with a selection of photos on a device, or with a camera view 330 as illustrated in FIG. 3G. The user can then take a photo which can then be used to post a photo with lyrics superimposed over the photo, such as illustrated in the photo 400 illustrated in FIG. 4.

In some embodiments, the lyric, or other published work may be superimposed over the selected picture. Additionally or alternatively, users can select location of the text on the picture, font size and style for the text, etc. An example of such functionality is illustrated in FIG. 4.

Further, a user may be able to filter posts by images. For example, FIG. 3B illustrates that a user could select an images button 321 that causes the feed page 316 to show different images that a user has chosen to share in conjunction with sharing lyrics.

Embodiments may facilitate and allow user input that includes a user entering a portion of a work that the user is currently listing to. For example, in one embodiment, entering a portion of a work comprises entering an audio portion of a song, such as by the user allowing or requesting the system to sample music and/or lyrics. In particular, the system may have functionality that allows the system to detect composition elements of a work such as the tune of a song. Alternatively or additionally embodiments may include speech recognition that recognizes lyrics. This can be used as input to find other portions of the work that a user is currently listening to or otherwise consuming. In an alternative embodiment, entering a portion of a work may include allowing the system to obtain a tag, such as an MP3 tag from a currently playing work.

In some embodiments, followers of a user using the lyric sharing service may be referred to as “audience” or “fans”.

In some embodiments, approval of someone's lyric, is done by a user clicking on a small “rock-on” hand symbol or some other user interface element stating they “like” the post. A display can then be made on the feed page (such as feed page 316) indicating the number of likes and/or who liked a particular lyric or other posting. For example, the feed page 316 illustrates a like badge counter 334 showing the number of people who liked a lyric. Clicking or hovering over (or other interaction) the like badge counter 334 may reveal what other users like the post.

Users can comment on a lyric post by selecting a comment interface element that allows the user to post a comment about a lyric. Information on the number of comments and the comments can be displayed to other users. For example, the feed page 316 illustrates a comment badge counter 336 that a user can select. The comment badge counter 336 displays the number of comments for a lyric post. In some embodiments, a user can select the comment badge counter 336 which then causes one or more of displaying comments made by users or allowing a user to enter a comment.

Embodiments may further include functionality allowing a user to re-posting a lyric post. For example, a user can repost a lyric post, by selecting an appropriate user interface element, from one of their friends or a post that has been sent to them. This causes the lyric post to be posted to the user's feed page, allowing that users friends to be notified and/or view the lyric post.

Embodiments may further include functionality allowing a user to get notifications on likes, comments, and re-posts of lyric post. Theses notification may be sent, for example, by email, by an alert and/or badge counter on a user device that allows the user to be notified, or by other means. Similarly, a user may get a notification on people including them in a lyric post or a comment.

Embodiments may further include functionality allowing a user to inviting friends from other social media apps or sites to join the lyric posting site and/or to use the lyric posting app.

Each user can have an archive. This archive will keep a record of the user's Lyric Posts. It may be opened to the public if the user so chooses. In some embodiments, this may be referred to as a user's “Discography” or “Lyriology”.

The live feed containing the user's lyric posts on the system site may be referred to in some embodiments as a “Sound Board” or “Lyric Board”.

Embodiments may provide users options to block certain individuals indefinitely and for individual posts. For example, assume a user got into a fight with their boyfriend and she was upset at him that day. She wanted to vent to friends/followers through a lyric post but did not want him to see it. Instead of blocking him entirely, she would just block him from that particular post. She could vent in peace to all her friends/followers. In some embodiments blocking someone may be referred to as “muting” them.

While the above example illustrates posting lyrics and songs, other embodiments may be used to post all or parts of other published works. For example, published works such as a poem, an article, film or TV dialogue, religious works, etc. could be posted. A user could type in part of one of these works, or similar text entries that could be related to a work. The system could then provide the user the ability to select particular portions of other works. For example, a user may enter the text “four score” or “last devotion” (as opposed to “last full measure of devotion”. The system may then provide the user with all or various portions of the Gettysburg Address which the user can select and post as their status. In particular, the Gettysburg Address would be displayed in a user interface which allows a user to select portions. The user interface would also include functionality to allow the user to post the selected portions. Individuals who read the users post may be given the ability by the system to download the entire Gettysburg Address or provided with a link to a website that has published the Gettysburg Address. Similar functionality could be accomplished with scripture verses, movie dialogue, or other published works.

In some embodiments, a user may attach a photo to a status that has been selected from a published work as described above. For example, a user may update their status to include lyrics from the Beach Boys song “Surfing USA”. The user may also attach a photo of a surf scene to their status.

Songs being listened to by the user may be posted/displayed via a music player within the application. For example, a user is at the gym and wants to post the songs they listen to on their “workout” playlist. Embodiments may include functionality where simply playing the songs allows them to be shared with others.

Embodiments may implement live track listening which comprises the social media broadcast of music. Users (e.g. celebrities, athletes, individual users, etc.) can allow their followers to listen to their own music with them whenever they want substantially to the very second or within a reasonable similar time frame. Substantially, as used herein implies that a reasonable difference in time may be allowed depending on a given circumstance. In some cases substantially may be some time less than a second. In some cases substantially may be some time less than a minute. In some cases substantially may be some time less than an hour. In some cases it may even be some time less than a day. Various specific limits may be established. For example, consider the case where an Olympic event is being held in a time zone several hours different than viewers who will be watching the event. The viewers may see an athlete listening to a song, but this may have occurred hours previously as the event is being broadcast on a time delay of several hours. However, when a user chooses to listen to what the athlete is listing to, they should be able to listen to what the athlete listened to at the event and not necessary what the athlete is listening too at the present time (although the user could choose to hear that instead). Thus, in some embodiments, a user may be able to listen to a song at the same time as a delayed broadcast of an event is occurring showing a another person listing to the song.

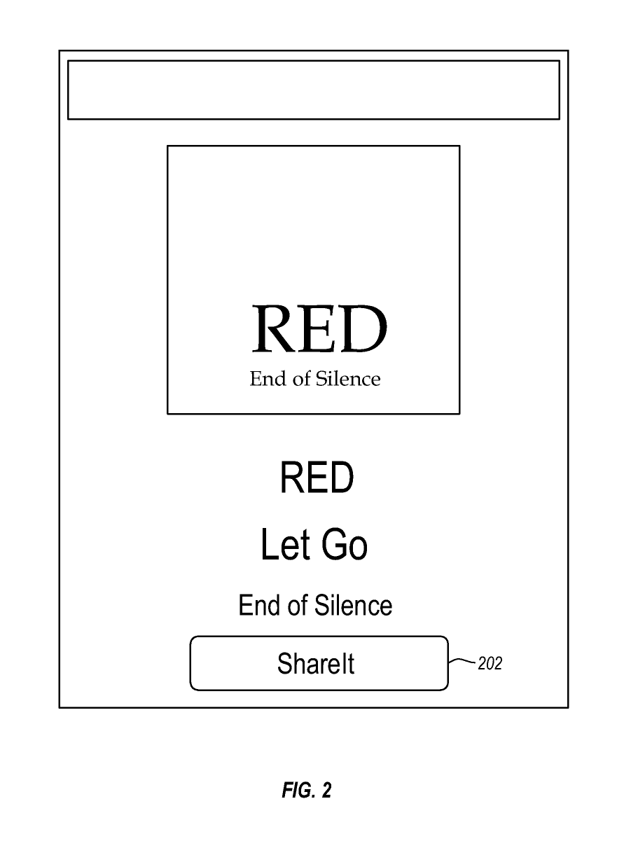

In another example: a star basketball player pulls out his smart phone to listen to some pump up music before Game 5 of the NBA finals. He wants his followers to join in and listen to his music with him live within the very second. He posts the song he's currently listening to through a smart phone application. An example of such an application is illustrated in FIG. 2. FIG. 2 illustrates the song the user is listening to and a button 202 that allows the user to share the song. Alternatively, FIG. 3C, a user is able to select a “listening to” button 332 that allows them to share the song that they are currently listening to. The song then shows up live in his social media pages/profiles. For example, the user may see a status entry for the basketball player on a social media website where the status entry includes a music player plug in displayed in the browser at the status entry. A follower will then see player's post and be able to join in listening to the song only if: the follower already owns the track and a local app at the follower's device identifies the song in their music library or if the follower does not currently own the track but decides to purchase the song which is facilitated by the service by using affiliate music providers, to then be able to listen to it live with the player.

Thus embodiments may include functionality for allowing users to share a song that they are currently listening too. In particular, a system may have functionality for determining that a first user wishes to share a song that the first user is listening to and the song that a first user is listening to. The system can further determine the tracker location of the song that the first user is listening to which indicates the location that the first user is at in the song. The song and the tracker location can be published to a social network. The social network can provide the song and tracker information to other users to allow the other users to listen to the same song at substantially the same location as the first user is listening to the song. Thus, other users can follow very closely, and in some cases to be exact second, what the first user is listening to.

Other users can participate in a number of different ways. For example the other users may participate by accessing a social networking website that is able to display the song and the tracker location. Alternatively, a user may have an “app” on their system, whether that system is a traditional computer system, portable music player, consumer electronic device, smart cell phone, or other device. If a user has the song on their system, then the user can click a link which opens a music application on the user's system and plays the song at beginning at the tracker location published and social network. If the user does not have the song on their system, then the user can be offered an opportunity to purchase the song, download the song, and once downloaded begin listening and a tracker location that corresponds to where the first user is currently listening to the song.

Embodiments may include functionality for illustrating other details in a user interface. For example embodiments may include functionality for displaying the number of users currently listening substantially simultaneously to a song at substantially the same location (or listening to the song in general). Alternatively or additionally, embodiments may include functionality for displaying different songs that different users are listening to. Thus, a user may be able to select any one of a number of different users currently listening to different songs and follow along with one or more of those users.

There are apps available on phones where an individual can cut out a section of a song to use as a ring tone or text message alert. All those apps work well but can become a hassle to get the final product back onto a user's phone. When a user hears a song they like they will instantly be able to upload the lyric section they select to use as a ringtone/alert. They will have a small link by the lyric to “rip” that section of the song. This link will provide a small highlight bar, which they can hover over the portion of the song with a box showing the allotted amount of time given them to use to then save that portion of the song. This portion would then save to a couple places, namely their iTunes or other library as a backup and their own page/service provided application where they can pull from to put on their phone.)

The idea of “zip code notification” is based on followers being notified when a band they follow through the service site (or other affiliate site) is coming to their city to perform in concert. When users register on the service site for the first time they will be prompted to enter their zip code for this very purpose. These zip codes will allow bands to notify all their fans when they are headed to their locale 1, 2, even 3 months in advance so they can plan for the show and get tickets as soon as they go on sale. Many times fans are never really aware of when their favorite bands come to town. This issue is addressed by both making the band's fans aware of this important info and helping the bands sell more tickets to their shows!

Example: It's May 1^{st} and U2 plans to perform live in Los Angeles on August 1^{st} at the Staples Center. They send out a zip code notification to everyone in the service site that has “liked” them within a 100 mile radius of the Staples Center/venue (or however far out the band chooses) letting their fans know 3 months in advance that's where they'll be playing on 8/1 and that tickets go on sale in a week. Some embodiments may include functionality for selling tickets through the service. This will keep fans well aware of the favorite band's next visit and allow them to procure tickets well in advance of the show.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

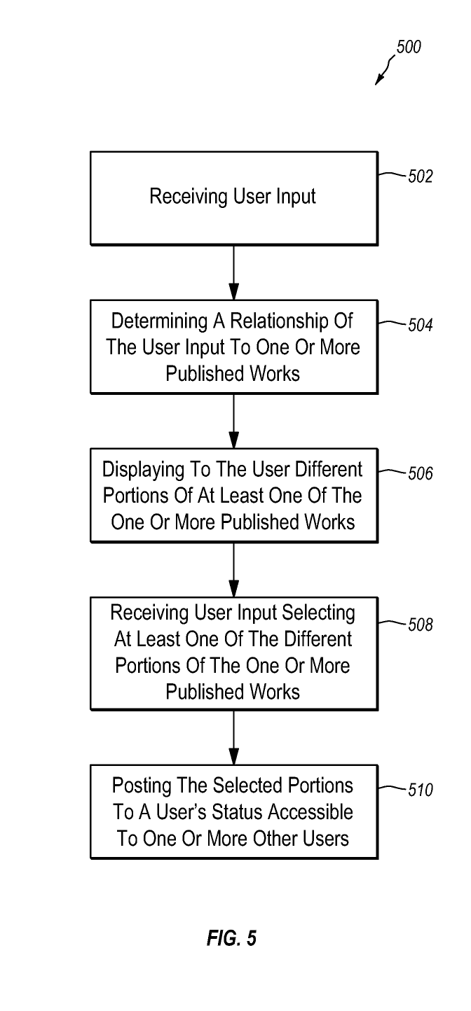

Referring now to FIG. 5, a method 500 is illustrated. The method 500 may be practiced in a social networking computing environment. The method includes acts for providing a user status. The user status includes a portion of a published work. The method 500 includes receiving user input (act 502). For example, as illustrated in FIG. 1B, a user inputs lyrics of a song.

The method 500 further includes determining a relationship of the user input to one or more published works (act 504). For example, as illustrated above in FIG. 1C, a system may determine songs or albums that include the user input.

The method 500 further includes displaying to the user different portions of at least one of the one or more published works (act 506). For example, as illustrated above a user may select one of the songs or albums shown in FIG. 1C. Then, as illustrated in FIG. 1D, the user is presented with selectable portions of a song. In other embodiments, the user may be presented with text that may be selected by highlighting.

The method 500 further includes receiving user input selecting at least one of the different portions of the one or more published works (act 508). For example, as illustrated in FIG. 1E, a user can select a checkbox next to some lyrics to select that portion of the song. Alternatively, embodiments may allow a user to highlight portions of a song.

The method 500 further includes posting the selected portions to a user's status accessible to one or more other users (act 510). For example, FIG. 1F illustrates a button that allows a user to post the selected lyrics to a user status.

While in the illustrated example, the published work is illustrated as a song, it should be appreciated that other embodiments may be implemented. For example, the published work may be a song, a poem, an article, film or TV dialogue, religious works, etc.

The user input may be any of a number of different inputs. For example, the user input may include a user entering a song lyric. Alternatively or additionally, the user input may include a user entering a text string. Alternatively or additionally, the user input may include a user entering a keyword. Alternatively or additionally, the user input may include a user entering a portion of a work that the user is currently listing to. For example, entering a portion of a work may include entering an audio portion of a song, such as by the user allowing the system to sample music and/or lyrics. Alternatively or additionally, entering a portion of a work may include allowing the system to obtain a tag, such as an MP3 tag from a currently playing work.

The method 500 may be practiced where determining a relationship of the user input to one or more published works determines that the user input is a portion of the one or more published works.

The method 500 further includes receiving user input selecting an image. In some such embodiments, posting the selected portions to a user's status accessible to one or more other users may include posting the selected portions to a user's status superimposed over the image. An example of this is illustrated in FIG. 2.

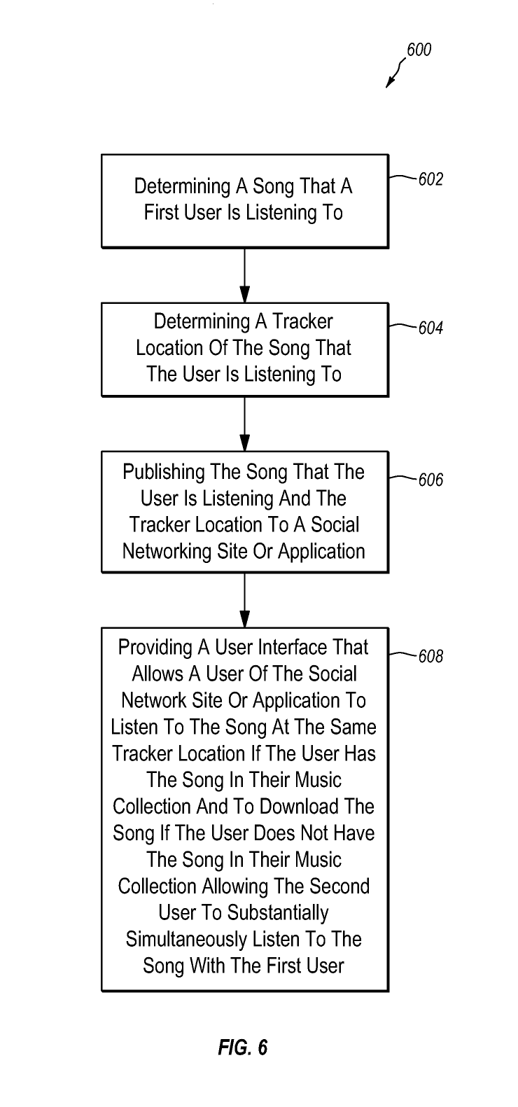

Referring now to FIG. 6, a method 600 is illustrated. The method 600 may be practiced in a social networking computing environment. The method 600 includes acts for providing real time indication of a song that a user is listening to. The method 600 includes comprising determining a song that a first user is listening to (act 602). The method further includes determining a tracker location of the song that the user is listening to (act 604).

The method 600 further includes publishing the song that the user is listening and the tracker location to a social networking site or application (act 606).

providing a user interface that allows a user of the social network site or application to listen to the song at the same tracker location if the user has the song in their music collection and to download the song if the user does not have the song in their music collection allowing the second user to substantially simultaneously listen to the song with the first user (act 608).

The method 600 may be practiced where determining a song that a first user is listening to includes receiving user input from a social networking application that a user wishes to share the song. The social networking application may include a link to a music player application to obtain music tags.

The method 600 may be practiced where the user interface shows the tracker location of the song.

The method 600 may be practiced where the user interface shows the number of users listening substantially simultaneously to a song.

The method 600 may be practiced where the user interface shows a list of listening users listening to songs.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a social networking computing environment, a method of providing a user status, the user status comprising a portion of a published work, the method comprising:
receiving user input;
determining a relationship of the user input to one or more published works;
displaying to the user different portions of at least one of the one or more published works;
receiving user input selecting at least one of the different portions of the one or more published works; and
posting the selected portions to a user's status accessible to one or more other users.

2. The method of claim 1, wherein the published works are at least one of a song, a poem, an article, film or TV dialogue, or religious works.

3. The method of claim 1, wherein the user input comprises a user entering a song lyric.

4. The method of claim 1, wherein the user input comprises a user entering a text string.

5. The method of claim 1, wherein the user input comprises a user entering a keyword.

6. The method of claim 1, wherein the user input comprises a user entering a portion of a work that the user is currently listing to.

7. The method of claim 6 wherein entering a portion of a work comprises entering an audio portion of a song, such as by the user allowing the system to sample music and/or lyrics.

8. The method of claim 6 wherein entering a portion of a work comprises allowing the system to obtain a tag, such as an MP3 tag from a currently playing work.

9. The method of claim 1, wherein determining a relationship of the user input to one or more published works determines that the user input is a portion of the one or more published works.

10. The method of claim 1, further comprising receiving user input selecting an image, and wherein posting the selected portions to a user's status accessible to one or more other users comprises posting the selected portions to a user's status superimposed over the image.

11. In a social networking computing environment, a method of providing real time indication of a song that a user is listening to, the method comprising:
determining a song that a first user is listening to;
determining a tracker location of the song that the user is listening to;
publishing the song that the user is listening and the tracker location to a social networking site or application;
providing a user interface that allows a user of the social network site or application to listen to the song at the same tracker location if the user has the song in their music collection and to download the song if the user does not have the song in their music collection allowing the second user to substantially simultaneously listen to the song with the first user.

12. The method of claim 11, wherein determining a song that a first user is listening to comprises receiving user input from a social networking application that a user wishes to share the song, and wherein the social networking application comprises a link to a music player application to obtain music tags.

13. The method of claim 11, wherein the user interface shows the tracker location of the song.

14. The method of claim 11, wherein the user interface shows the number of users listening substantially simultaneously to a song.

15. The method of claim 11, wherein the user interface shows a list of listening users listening to songs.
